(19) United States
(12) Patent Application Publication
(10) Pub. No.: US 2025/0312712 A1
(43) Pub. Date: Oct. 9, 2025

(54) FRY FILTER

(71) Applicant: Erika Santiago, Maspeth, NY (US)

(72) Inventor: Erika Santiago, Maspeth, NY (US)

(21) Appl. No.: 18/626,394

(22) Filed: Apr. 4, 2024

(51) Int. Cl. B01D 29/05; A47J 37/10; A47J 37/12; B01D 29/96; B01D 39/12

(52) U.S. Cl. CPC B01D 29/05; A47J 37/108; A47J 37/1223; B01D 29/96; B01D 39/12

(57) ABSTRACT

A frying filter that sits at the bottom of a frying pan full of oil or pot full of oil which can be lifted out of the frying pan or pot by a handle to also lift out the cooked food and any debris/particles of food that are created by cooking the food to instantaneously clean the cooking oil for future re-use. The frying filter includes a micron mesh which will filter out debris/particles of any size which are floating in the cooking oil.

### STATEMENT REGARDING FEDERALLY SPONSORED RESEARCH OR DEVELOPMENT

Not applicable.

### COPYRIGHT NOTICE

A portion of this disclosure contains material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever. 37 C.F.R 1.71(d).

### BACKGROUND OF THE INVENTIVE CONCEPT

### 1. Field of the Invention

The present inventive concept relates to a fry filter configured to leave cooking oil clean and free of all remaining particles after the cooking oil is used to fry foods. More particularly, but not exclusively, the present inventive concept relates to a fry filter configured to leave cooking oil clean and free of all remaining particles after the cooking oil is used to fry foods by fine filtering the oil with a super-fine micron mesh.

### 2. Description of the Related Art

When frying foods in a frying pan or pot filled with a frying oil, especially foods coated in bread crumbs, flour, etc., a large amount of fried bits/particles separate from the food and settle at the bottom of a frying pan or pot. These fried bits and particles cause the oil to become unusable after one or two uses since these bits and particles stay in the oil after a first use only to become burned after the first or second use of the frying oil, thus destroying the taste of the frying oil itself, and hence any foods fried in the frying oil thereafter.

Attempts to create a device to sift out fried bits in cooking oils used to fry foods have been presented. For example, U.S. Pat. No. 7,021,202 by Sizer discloses a disposable deep-fry pot liner 12 and disposable strainer 14 to fit within the pot liner 12. The disposable deep-fry pot liner 12 and disposable strainer 14 are intended to rest in an non-disposable pan, pot, or kettle P. The strainer 14 includes holes 28 and 30 to allow liquid cooling oil to drain from the strainer 14 when removing the cooked food. However, once the strainer 14 is lifted out of the pot liner 12 stray bits and particles of food flow through the holes 28 and 30 to remain in the frying oil within the liner 12. Since the liner and strainer 14 are intended to be disposed of the frying oil must also be disposed of since this oil still contains the bits and particles which separate from the food being fried.

U.S. Pat. No. 8,820,222 by Cloutier et al. discloses a cooking assembly 20 including a cooking pan 22 with an insert 24 having a perforated portion which can retain foods within the pan 22 while allowing the fluid/oil to be removed therefrom. However, although the insert 24 catches the food after the food is done being cooked in the oil the entire oil must be poured out together with any remaining bits and particles that break free of the food being fried. As a result, the oil continues to have the bits and particles therein and becomes contaminated, thus rendering the cooking oil useless after one or two uses.

U.S. Pat. No. 10,582,804 by Chaudry et al. discloses a cooking apparatus including a cooking pan 10 with a pivoting grease strainer 20. The pivoting grease strainer 20 includes first and second hinged contact points 28 and 30 while allow the strainer 20 to move between a closed position and a raised, draining position and includes a plurality of aligned elongated slits 38 to block the passage of solid food therethrough. In the draining position the strainer 20 extends above a limited segment of a peripheral wall 16 and upper curved rim 26 exposing perforations, thereby enabling the passage of liquid from the interior of the pan to the exterior of the pan 10 while blocking food. However, when the oil is poured through the elongated slits 38 bits and particles of the food also flow through the slits 38 such that the oil continues to have the bits and particles therein and becomes contaminated, thus rendering the cooking oil useless after one or two uses.

There is a need for an oil frying filter which will sift all size debris/particles of food out of frying oil after food is done being fried in the frying oil such that the frying oil remains clean and free of debris/particles which remain after food is fried.

There is also a need for an oil frying filter which can instantaneously remove all size debris/particles from cooking oil immediately after food is done being fried in the cooking oil.

There is also a need for an oil frying filter which can instantaneously remove all size debris/particles from cooking oil while the cooking oil is still hot such that the free floating debris/particles don't settle in cooled cooking oil.

### SUMMARY OF THE INVENTIVE CONCEPT

The present general inventive concept provides a fry filter configured to leave cooking oil clean and free of all remaining debris/particles after the cooking oil is used to fry foods by fine filtering the oil with a super-fine micron mesh immediately after food is done being fried in the cooking oil.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a fry filter, including: a ring shaped frame including a flat main body and an inward curved side extending from the main body and configured to sit flat on a bottom surface of a frying pan or pot; a micron mesh fixed to the entire inward curved side of the ring shaped frame; and a handle including a first end fixed to an inner side of the main body of the ring shaped frame, a middle portion extending substantially in parallel with the main body of the ring shaped frame and a second end extending outward from the middle portion and substantially in parallel with the micron mesh.

In an example embodiment, the fry filter further includes a heat resistance cover fixed over a portion of the second end of the handle.

In another example embodiment, the ring shaped frame and handle are formed of a stainless steel.

In still another example embodiment, the micron mesh is formed of fine metal wires.

In yet another example embodiment, the first end of the handle is fixed to the inner side of the main body of the ring shaped frame with rivets

The foregoing and/or other features and utilities of the present general inventive concept may also be achieved by providing a fry filter, including: a circular hollow rim including one side thereof curved inward; a micron mesh fixed along the entire curved inward side of the circular hollow rim; and an elongated handle fixed at a first end thereof to an inner side of the circular hollow rim and a second end bent outward to enable a user to grip the handle to lift the fry filter.

In an example embodiment, the fry filter further includes a heat resistant cover disposed over the second end of the handle to prevent heat from the handle to burn a user's hand when gripping the heat resistant cover.

In another example embodiment, the circular hollow rim and handle are formed of a stainless steel.

In still another example embodiment, the micron mesh is formed of fine metal wires.

In yet another example embodiment, the first end of the handle is fixed to the inner side of the circular hollow rim with rivets.

Additional features and utilities of the present general inventive concept will be set forth in part in the description which follows and, in part, will be obvious from the description, or may be learned by practice of the general inventive concept.

### BRIEF DESCRIPTION OF THE DRAWINGS

These and/or other features and utilities of the present inventive concept will become apparent and more readily appreciated from the following description of the embodiments, taken in conjunction with the accompanying drawings of which:

FIG. 1 illustrates a top plan view of a fry filter according to an example embodiment of the present inventive concept.

FIG. 2 illustrates an elevated side view of the fry filter according to the example embodiment illustrated in FIG. 1.

FIG. 3 illustrates an expanded partial front view of the fry filter according to the example embodiment illustrated in FIGS. 1 and 2.

FIG. 4 illustrates a side plan view of the fry filter according to the example embodiment illustrated in FIGS. 1 and 2 in operation.

The drawings may illustrate a few example embodiments of the present inventive concept and are not to be considered limiting in its scope, as the overall inventive concept may admit to other equally effective embodiments. The elements and features shown in the drawings are to scale and attempt to clearly illustrate the principles of exemplary embodiments of the present inventive concept. In the drawings, reference numerals designate like or corresponding, but not necessarily identical, elements throughout the several views.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures. Also, while describing the present general inventive concept, detailed descriptions about related well-known functions or configurations that may diminish the clarity of the points of the present general inventive concept are omitted.

Reference will now be made in detail to the example embodiments of the present general inventive concept. It will be understood that although the terms “first” and “second” are used herein to describe various elements, these elements should not be limited by these terms. These terms are only used to distinguish one element from another element. Thus, a first element could be termed a second element, and similarly, a second element may be termed a first element without departing from the teachings of this disclosure.

Expressions such as “at least one of,” when preceding a list of elements, modify the entire list of elements and do not modify the individual elements of the list.

All terms including descriptive or technical terms which are used herein should be construed as having meanings that are obvious to one having ordinary skill in the art. However, the terms may have different meanings according to the intention of the inventors, case precedents, or the appearance of new technologies. Also, some terms may be arbitrarily selected by the inventors, and in this case, the meaning of the selected terms will be described in detail in the detailed description herein. Thus, the terms used herein have to be defined based on the generally defined meaning of the terms together with the descriptions provided throughout this specification.

Hereinafter, one or more exemplary embodiments of the present general inventive concept will be described in detail with reference to accompanying drawings.

Example embodiments of the present general inventive concept are directed to a fry filter configured to leave cooking oil clean after used to fry foods. More particularly, but not exclusively, the present inventive concept relates to a fry filter configured to leave cooking oil clean after used to fry foods by fine filtering the oil with a super-fine mesh.

Frying food in a frying pan or pot full of cooking oil can leave behind lots of small debris and particles which can burn and make the oil become dirty. The present inventive concept has been designed to make it easy for a user to clean used oil without having to use a separate oil strainer, as described in detail below.

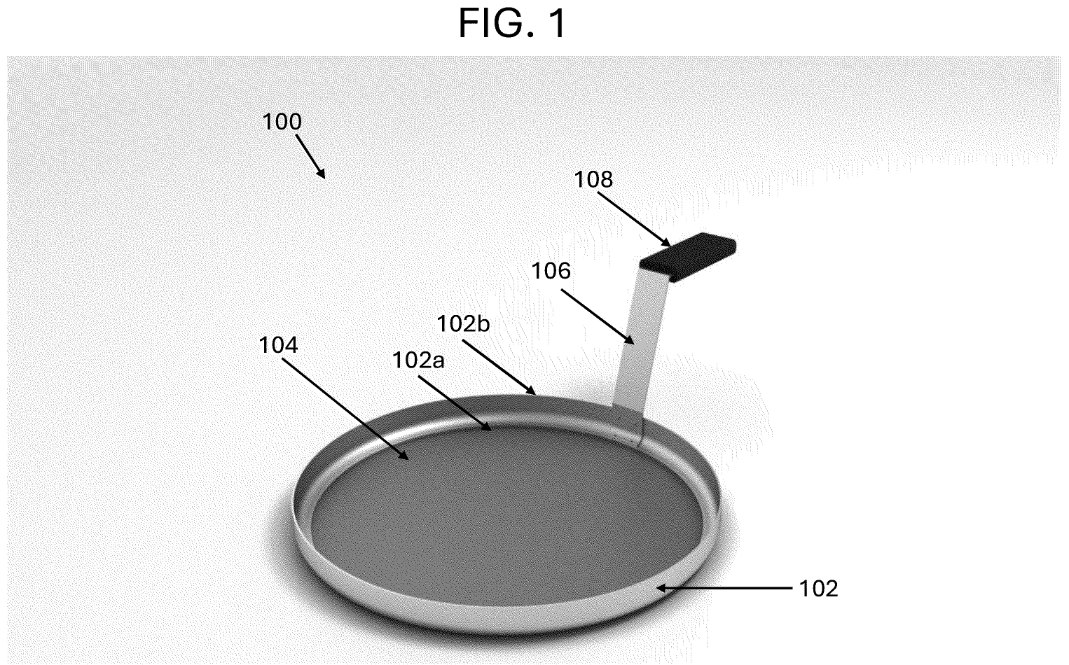

FIG. 1 illustrates a top plan view of a fry filter 100 according to an example embodiment of the present inventive concept. Referring to FIG. 1 the fry filter 100 can include an innovative circular frame 102 which curves outward and upward from circular inner bottom portion 102a, which can sit flat on the bottom of a frying pan or pot, to a circular top portion 102b. The circular frame 102 can be configured to sit within a frying pan such that an outer circumferential surface of the frame 102 rests adjacent to or in contact with an inner wall of the frying pan or pot, thus making the fry filter 100 seamlessly fit into any size frying pan or pot. The circular frame 102 can be made from a stainless steel or other type of metal which will withstand the high temperatures of boiling oil. The circular frame 102 can be manufactured to different sizes to fit into different size pans and pots.

The fry filter 100 according to this example embodiment can further include an elongated handle 106 which can be attached at a first end thereof to an inner surface of the circular frame 102 and can extend upward from the frame 102 by several inches to terminate at a second end thereof such that the fry filter 100 can rest within and at a bottom of tall pots without the handle 106 hitting the sidewalls of a frying pan or pot. Attached along the circular inner bottom portion 102a of the frame 102 is a super-fine mesh 104, for example, a micron mesh, which is configured to filter out any size food debris and particles from the cooking oil when the fry filter 100 is lifted out of the corresponding frying pan or pot containing frying oil therein. The micron mesh 104 is preferably made of woven wires with a mesh count sufficient to allow oil to flow through the woven wires while blocking particles and small debris from flowing therethrough.

The innovative circular (i.e., ring shaped) frame 102 is configured to rest on the bottom of a frying pan or pot while the outer side wall rests adjacent to or in contact with the inner side wall of the frying pan or pot such that debris and particles which separate from food fried in cooking oil is caught therein. More specifically, while the outer side surface of the circular frame 102 rests adjacent to or in contact with an inner side surface of a frying pan or pot the super-fine mesh 104 will rest at the bottom of the frying pan or pot full of cooking oil. Accordingly, after food is fried in the cooking oil the fry filter 100 can be lifted out of the frying pan or pot full of cooking oil, thus lifting the fried food and any free-floating debris and particles out of the cooking oil and leaving the cooking oil clear and clean to be used again.

According to an example embodiment the second end of the elongated handle 106 can include an insulating plastic handle cover 108. This handle cover 108 can be made from polytetrafluoroethylene or other similar material which will provide a secure grip which prevents heat from penetrating therethrough and burning a user's hand.

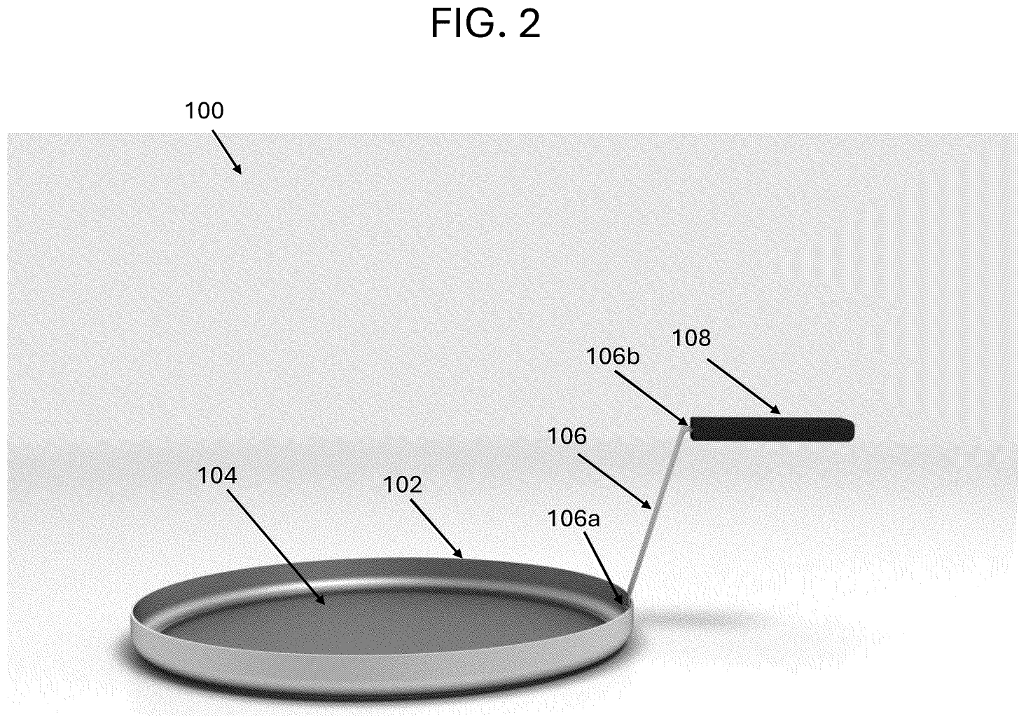

FIG. 2 illustrates an elevated side view of the fry filter according to the example embodiment illustrated in FIG. 1. As illustrated in FIG. 2 the handle 106 can be fixed at the first end 106a thereof to the inner surface of the frame 102 and then extend upward and slightly outward by a predetermined length before bending at the second end 106b thereof, where the second end 102b can extend in a direction which is parallel with the frame 102. The second end 106b of the handle 106 can extend outward by a predetermined length sufficient to enable a user to grip the second end 106b of the handle 106 to place the fry filter 100 into a frying pan or pot and to lift the fry filter 100 out of the frying pan or pot. The handle 106 can be formed of an aluminum metal. However, the handle can be formed of any type of metal which will perform the intended purposes as described herein. Along the second end 102b of the handle can be disposed the insulating plastic handle cover 108.

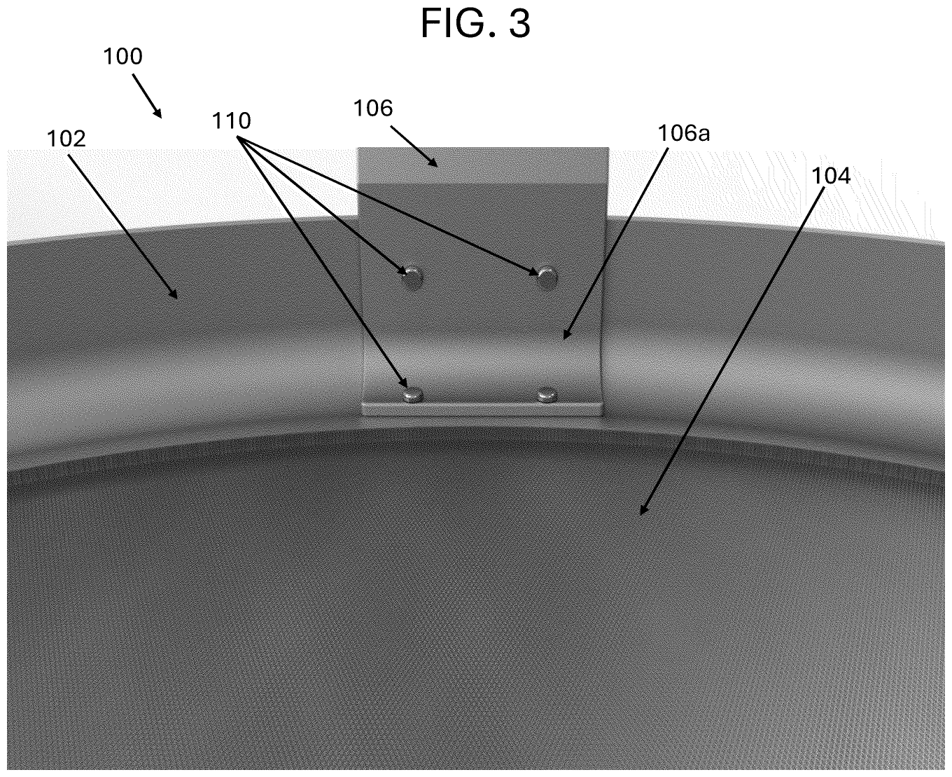

FIG. 3 illustrates an expanded partial front view of the fry filter according to the example embodiment illustrated in FIGS. 1 and 2. As illustrated in FIG. 3 the first end 106a of the handle 106 can include a plurality of rivets 110 which can be used to fix the first end 106a of the handle 106 to the inner surface of the frame 102. The first end 106a of the handle 106 can have a curved shape in order to sit completely against the inner surface of the curved wall of the circular frame 102. Alternatively, the first end 106a of the handle 106 can be attached to the inner surface of the frame 102 by other means, such as, for example welding or screws, which will ensure that the handle 106 remains fixed to the frame 102.

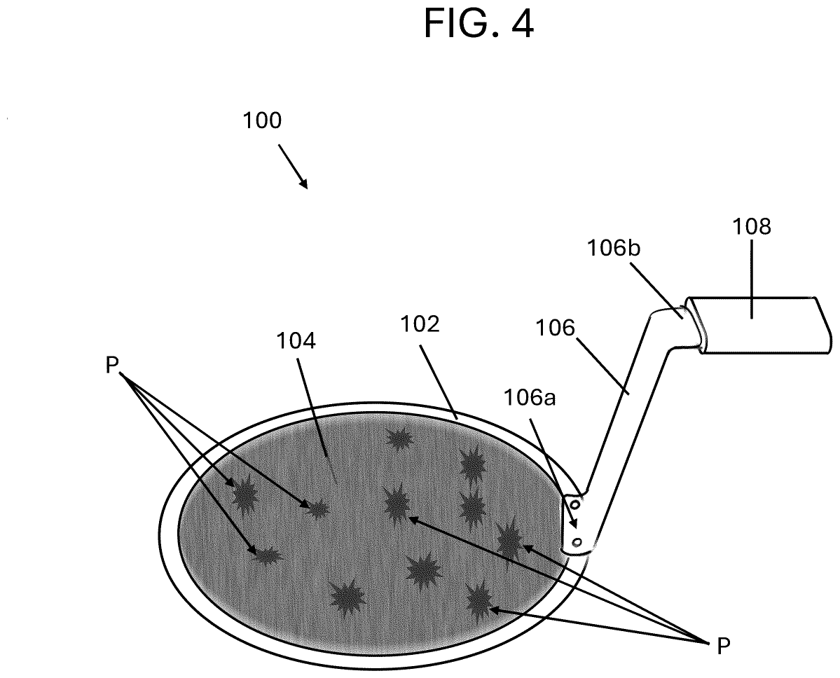

FIG. 4 illustrates a side plan view of the fry filter 100 according to the example embodiment illustrated in FIGS. 1 and 2 in operation. As illustrated in FIG. 4, after frying food is completed within cooking oil in a frying pan or pot the fry filter 100 can be lifted out of the frying pan or pot, thus also lifting the cooked food out of the cooking oil. Further, the super-fine mesh 104 will also lift any small pieces of debris/particles (P) out of the cooking oil which have separated from the food, thus leaving the cooking oil clean and clear for future use. The super-fine mesh 104 can be easily cleaned of any oil and small pieces of debris/particles (P) by wiping with a paper towel or rinsing under warm running water.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A fry filter, comprising:
a ring shaped frame including a flat main body and an inward curved side extending from the main body and configured to sit flat on a bottom surface of a frying pan or pot;
a micron mesh fixed to the entire inward curved side of the ring shaped frame; and
a handle including a first end fixed to an inner side of the main body of the ring shaped frame, a middle portion extending substantially in parallel with the main body of the ring shaped frame and a second end extending outward from the middle portion and substantially in parallel with the micron mesh.

2. The fry filter according to claim 1, further comprising a heat resistance cover fixed over a portion of the second end of the handle.

3. The fry filter according to claim 1, wherein the ring shaped frame and handle are formed of a stainless steel.

4. The fry filter according to claim 1, wherein the micron mesh is formed of metal wires.

5. The fry filter according to claim 1, wherein the first end of the handle is fixed to the inner side of the main body of the ring shaped frame with rivets.

6. A fry filter, comprising:
a circular hollow rim including one side thereof curved inward;
a micron mesh fixed along the entire curved inward side of the circular hollow rim; and
an elongated handle fixed at a first end thereof to an inner side of the circular hollow rim and a second end bent outward to enable a user to grip the handle to lift the fry filter.

7. The fry filter according to claim 6, further comprising a heat resistant cover disposed over the second end of the handle to prevent heat from the handle to burn a user's hand when gripping the heat resistant cover.

8. The fry filter according to claim 6, wherein the circular hollow rim and handle are formed of a stainless steel.

9. The fry filter according to claim 6, wherein the micron mesh is formed of metal wires.

10. The fry filter according to claim 6, wherein the first end of the handle is fixed to the inner side of the circular hollow rim with rivets.
